(19) United States
(12) Patent Application Publication
(10) Pub. No.: US 2005/0174428 A1
(43) Pub. Date: Aug. 11, 2005

(54) Electronic endoscope apparatus capable of converting images into HDTV system

(75) Inventor: Kazunori Abe, Saitama-shi (JP)

Correspondence Address: SNIDER & ASSOCIATES, P. O. BOX 27613, WASHINGTON, DC, 20038-7613, US

(73) Assignee: Fujinon Corporation, Saitama-shi (JP)

(21) Appl. No.: 11/038,409

(22) Filed: Jan. 21, 2005

(30) Foreign Application Priority Data
Jan. 27, 2004 (JP) 2004-018897

(51) Int. Cl. H04N 7/18

(52) U.S. Cl. 348/65

(57) ABSTRACT

A processor device having electronic endoscopes having different number of pixels of CCDs is provided with a DVI circuit for generating a digital video signal of display standard of a personal computer, etc. and outputting it as a differential signal, and a high vision system converter is connected to and arbitrarily removed from the output side of the DVI circuit. In the high vision system converter, a video signal having different number of pixels is electronically scaled to a number of display pixels of, for example, an SXGA standard by detecting the number of pixels of the input digital video signal, and is displayed on a high vision screen. Thus, the resolution of the image of the CCD can be maintained.

### BACKGROUND OF THE INVENTION

The application claims the priority of Japanese Patent Applications No. 2004-18897 filed on Jan. 27, 2004 which is incorporated herein by reference.

1. Field of the Invention

The present invention relates to the configuration of an electronic endoscope apparatus, and more specifically to an electronic endoscope apparatus capable of outputting an image of an observation object to a monitor in a high vision television system in an environment in which various types of electronic endoscopes having different numbers of pixels of a solid-state image pickup element are used.

2. Description of the Related Art

An electronic endoscope apparatus is loaded with a CCD (charge coupled device), etc. which is a solid-state image pickup element at the tip portion of an electronic endoscope (electronic scope). The CCD captures an image of an observation object using the illumination of the light from the light supply device. A capture signal obtained by the CCD of the electronic endoscope is output to the processor device, and the processor device performs image processing. As a result, an image of an observation object can be displayed on the monitor, and a still image, etc. can be recorded on a recorder.

Normally, the above-mentioned image of an observation object is displayed on the NTSC monitor (aspect ratio of 3:4), which is a standard television system. For example, as described in Japanese Patent Laid-open Publication No. 4-253830, an image of an observation object is displayed on the monitor (aspect ratio of 9:16) in a high-quality high vision television (HDTV) system having about the double number of scanning lines. In the electronic endoscope apparatus, since a normal NTSC signal (analog signal) is formed from an output signal of a CCD, the NTSC signal is converted to a high vision television signal.

On the other hand, a still image (digital signal) of an observation object obtained by the electronic endoscope apparatus is recorded on the record medium in the filing device such as a personal computer, etc., and displayed and observed later on the personal computer monitor, and simultaneously the CCD uses an image of a large number of pixels indicating high resolution.

### SUMMARY OF THE INVENTION

As described above, the CCD, which is a solid-state image pickup element, has recently been realized as device for an image of a high resolution having a large number of pixels. Therefore, in displaying an image in the high vision television system, there is the advantage of observing a higher-quality image of an observation object as compared with the conventional technology. However, if an NTSC signal is converted to a high vision television signal as described above, there is the restriction by the resolution of the NTSC video signal, and the resolution of the CCD indicating high-quality image cannot be fully utilized.

Furthermore, the CCD for different numbers of pixels is loaded for the electronic endoscope, and if the difference in the number of pixels of the CCD and a change for a large number of pixels are supported by the arrangement or update (exchange) of a conversion circuit for a high vision television signal in a processor device, then the entire system is costly and generates an expensive apparatus.

Additionally, equipment for use in a medical field is requested to meet strict standards on the EMC (electromagnetic compatibility) and electric safety, and it is not practical to satisfy the medical standards in a dedicated large device such as a personal computer, etc. for conversion to a high vision television signal.

The present invention has been developed to solve the above-mentioned problem, and aims at providing an electronic endoscope apparatus which uses image output by digital processing for supply to a personal computer, etc., obtains an image in a high vision television system in a simple configuration at a low cost without reducing the resolution although an electronic endoscope loaded with solid-state image pickup elements having different numbers of pixels is connected, and can display an image in an easy observation state.

To attain the above-mentioned advantage, the first invention includes: various electronic endoscopes for capturing an image of an observation object using solid-state image pickup elements having different numbers of pixels; a processor device configured to be able to connect these various electronic endoscopes for generating an analog video signal and a digital video signal from a signal obtained by the solid-state image pickup element; a differential signal output unit which is arranged in the processor device, corresponds to the number of pixels of the solid-state image pickup element and generates a digital video signal in accordance with an external computer display standard, parallel-serial converts the digital video signal, and outputs a differential signal; a high vision system converter having a pixel number detection circuit which is connected to the differential signal output unit and can be arbitrarily removed from the differential signal output unit, and detects the number of pixels (size by the number of pixels, and image size) of a digital video signal according to a differential signal input from the differential signal output unit, converting a video signal to a high vision television signal, and outputting a resultant signal; and a display pixel number adjustment circuit, arranged in the high vision system converter, for matching the number of pixels of a video signal with the predetermined number of display pixels (display image size) by an electronic scaling (enlarging or reducing) based on output of the pixel number detection circuit.

In the first invention, the CCD which is a solid-state image pickup element can have various numbers of pixels. Therefore, the differential signal output unit (for example, a DVI) for output to a personal computer, etc. generates a digital video signal in accordance with the standards of a VGA (video graphics array) of 640 (horizontal direction)×480 (vertical direction) pixels, an XGA (extended graphics array) of 1024×768 pixels, an SXGA (super XGA) of 1280×960 pixels, 1280×1024 pixels, etc. After the video signal is parallel-serial converted, it is output as a differential signal to a monitor of a personal computer, etc. When the digital video signal which is a differential signal is supplied to a high vision system converter, the number of pixels of the video signal is detected, and a high vision television signal of the predetermined number of display pixels is generated based on the detected number of pixels. That is, in the display pixel number adjustment circuit, for example, an image of the size (number of pixels) of the standards of, for example, the XGA and VGA is electronically expanded and generated as an image of the size as the number of pixels of 1280×960, and a high vision television signal is obtained such that the pixel information of all the CCDs can be utilized. Therefore, only by connecting the high vision system converter to the processor device, an image of an observation object (moving picture or still image) can be observed by a high vision monitor, and an image of an observation object displayed by the same size by the number of pixels (screen area) can be observed even when having different number of pixels of CCD. The image can also be recorded on a high vision recorder.

According to the high vision system converter of the electronic endoscope apparatus of the above-mentioned first invention, although an electronic endoscope having a different number of pixels (resolution) for the CCD is connected using the output of the differential signal output unit for supply of a digital image to a personal computer, etc., an image by a high vision television system can be generated in a simple configuration and at a low cost without lowering the resolution of the CCD, an image of an observation object can be displayed and observed on a high vision monitor with the same size by the number of pixels, or recorded. Therefore, in a routine check, etc. in which a number of endoscopic images (moving pictures or still images) are observed, there is an effect of a quick and easy observation and diagnosis. Furthermore, by using the high vision system converter as an adapter device which satisfies the standards of EMC and electric safety required in a medical field, the observation of a high vision image in a medical field can be easily realized.

The second invention of the electronic endoscope apparatus includes: a display pixel number adjustment circuit, provided in a processor device, for matching the number of pixels of a video signal with the predetermined number of display pixels by electronic scaling; a differential signal output unit, provided in the processor device, for generating a digital video signal in accordance with an external computer display standard, parallel-serial converting the digital video signal, and outputting the resultant signal as a differential signal; and a high vision system converter, connected to and arbitrarily removed from the differential signal output unit, for converting the video signal having the predetermined number of display pixels to a high vision television signal, and outputting the resultant signal.

In the second invention, the display pixel number adjustment circuit is provided in the processor device, and an image having the same number of display pixels is generated before input to the differential signal output unit. In the high vision system converter, since the number of input pixels is known in advance, conversion to a high vision television signal can be performed without detecting the number of pixels. Also in this case, an image of an observation object can be observed with the same number of pixels (screen area) on the high vision monitor.

According to the second invention, the display pixel number adjustment circuit is provided in the processor device. Therefore, since the number of pixels of an input video signal is predetermined in the high vision system converter, there is the merit of unnecessary detection of the number of pixels (image size).

### BRIEF DESCRIPTION OF THE DRAWINGS

FIG. 1 is a block diagram of the circuit showing the configuration of the DVI circuit and the high vision system converter of the electronic endoscope apparatus according to the first embodiment of the present invention;

FIG. 2 shows the configuration of the HDTV signal conversion unit in the high vision system converter shown in FIG. 1;

FIG. 3 is a block diagram of the circuit showing the entire configuration of the electronic endoscope apparatus according to the first and second embodiments of the present invention;

FIG. 4A shows the detection of the number of pixels of a video signal of 1280×960 performed by the high vision system converter according to the embodiment of the present invention;

FIGS. 4B and 4C are explanatory views of the conversion to a high vision television signal and the display state;

FIG. 5A shows the display state on the high vision monitor of an XGA standard video signal generated by the high vision system converter according to the embodiment of the present invention; and

FIG. 5B is an explanatory view of the display state on the high vision monitor of a VGA standard video signal.

### DETAILED DESCRIPTION OF THE PREFERRED EMBODIMENTS

The display pixel number adjustment circuit according to the present invention is not only provided in the high vision system converter (first embodiment), but also provided in the processor device (second embodiment).

### First Embodiment

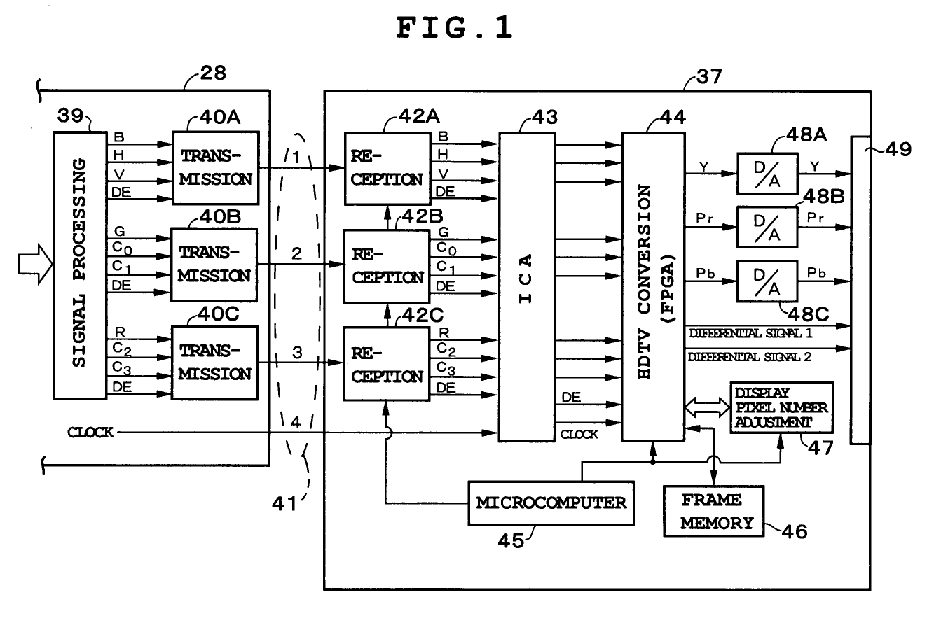

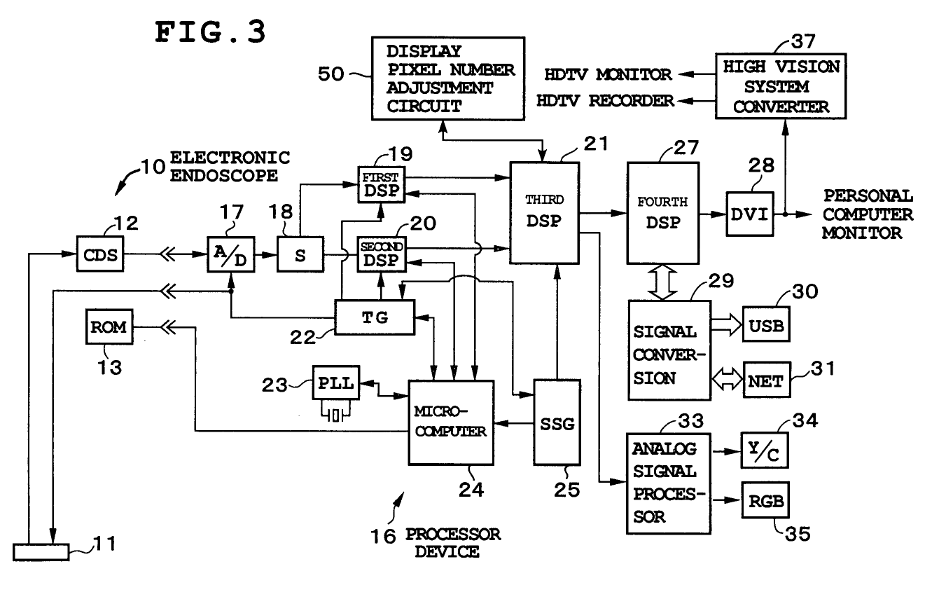

FIGS. 1 to 3 show the configurations of the electronic endoscope apparatus according to the first embodiment of the present invention. The entire configuration of the apparatus is first described below. In FIG. 3, an electronic endoscope (electronic scope) 10 is provided with CCDs 11 which are solid-state image pickup elements at the tip portion. The CCDs 11 can be various types for 400 thousand pixels, 80 thousand pixels, 1.31 million pixels, etc. A duplex correlation sampling (CDS) circuit 12 for sampling a capture signal output from the CCD 11, memory (EEPROM) 13 for storing the identification information, about the electronic endoscope 10, video processing information, etc. are also provided. The light of the light source device not shown in the attached drawings is supplied to the electronic endoscope 10 through a light guide, and an image of an observation object is captured by the CCD 11 by the illumination from the tip portion. Various electronic endoscopes 10 loaded with the CCD 11 having different number of pixels (or different transfer systems of the CCDs corresponding to the number of pixels) are connected to and arbitrarily removed from a processor device 16.

The processor device 16 is provided with an A/D converter 17, a first DSP (digital signal processor) 19 for various types of signal-processing on a video signal, a second DSP 20, a third DSP 21, a selector (S) 18 for selecting any of the DSPs 19 and 20, a timing generator 22 for supplying a synchronous signal or a timing signal to the circuits from the CCD 11 to the first DSP 19 and the second DSP 20, a PLL circuit 23 having a crystal oscillator, a microcomputer 24 for performing various control, and a synchronous signal generation circuit (SSG) 25 for supplying a synchronous signal and a timing signal to the third DSP 21, etc.

At the stages after the third DSP 21, a fourth DSP 27 for generating a digital video signal and a DVI (digital visual interface) circuit 28 are provided. The DVI circuit 28 generates a video signal in accordance with the display standard, for example, 640×480 (VGA), 1024×768 (XGA), 1280×960, 1280×1024 (SXGA), etc. for output to a pc monitor, etc., then parallel-serial converts the signal, and outputs the serial signal as a differential signal to a personal computer monitor, a filing device, etc. The DVI is a high-speed display interface, and adopts TMDS (transition minimized differential signaling) as a data format. On the other hand, the fourth DSP 27 is provided with a USB output unit 30 and a network output unit 31 through a signal conversion circuit 29, and a signal is output from the USB output unit 30 and the network output unit 31 in the respective output styles. Additionally, at the stage subsequent to the third DSP 21, an analog signal processor 33 for converting a digitized video signal to an analog signal, a Y/C signal output unit 34 for outputting a brightness (Y) signal and a color-difference (C) signal, and an RGB output unit 35 for outputting R (red), G (green), and B (blue) signals are provided.

Then, a high vision system converter 37 is provided as connected to and arbitrarily removed from an output unit (terminal) of the DVI circuit 28, and the output of the high vision system converter 37 is connected to a HDTV monitor and HDTV recorder. With the configuration shown in FIG. 3, a part of what is explained as a circuit in the processor device 16 can also be configured in the electronic endoscope 10.

FIG. 1 shows the detailed configuration in the DVI circuit 28 and the high vision system converter 37. The DVI circuit 28 is provided with a signal processing unit 39 for generating an image in accordance with each display standard, and transmission units 40A, 40B, and 40C for transmitting an RGB signal, a synchronous signal, a control signal, etc. The DVI circuit 28 is connected to the high vision system converter 37 through a serial transmission cable 41, and the high vision system converter 37 is provided with reception units 42A, 42B, and 42C respectively corresponding to the three transmission units 40A, 40B, and 40C, an ICA (inter channel alignment) unit 43, an HDTV (high vision television) signal conversion unit (FPGA: filed programmable gate array circuit) 44 for detecting the number of pixels of an image and generating a high vision television signal, a microcomputer 45 for executing various types of control, and frame memory 46 for temporarily storing an input video signal.

Then, a display pixel number adjustment circuit 47 for matching with a predetermined number of display pixels, for example, the number of pixels of the SXGA by electronically enlarging (or reducing) the image in accordance with the above-mentioned 640×480 (VGA), 1024×768 (XGA), 1280×960, and 1280×1024 (SXGA) is connected to the HDTV signal conversion unit 44. Between the HDTV signal conversion unit 44 and a connector 49, D/A converters 48A, 48B, and 48C are provided corresponding to Pr and Pb signals which are a brightness (Y) signal and a color-difference signal.

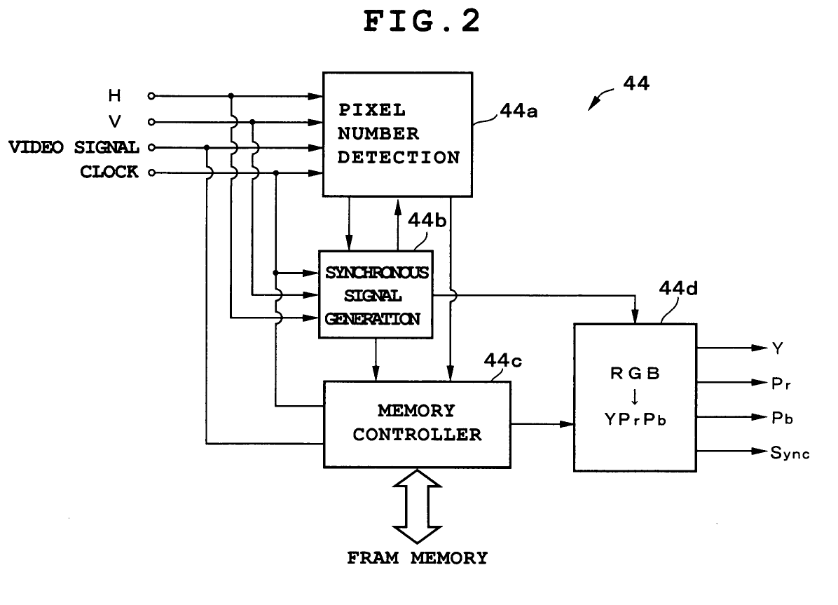

FIG. 2 shows the configuration of the HDTV signal conversion unit 44, and the HDTV signal conversion unit 44 is provided with a pixel number detection circuit 44a for receiving a horizontal synchronous signal (H), a vertical synchronous signal (V), a video signal, and a clock signal and detecting the number of pixels (image size) of a video signal, a synchronous signal generation circuit 44b for generating a high vision image, a memory controller 44c for controlling a write and a read of a video signal for the frame memory 46, and a signal converter 44d for converting an RGB signal output from the memory controller 44c to Y, Pr, and Pb signals which are high vision images.

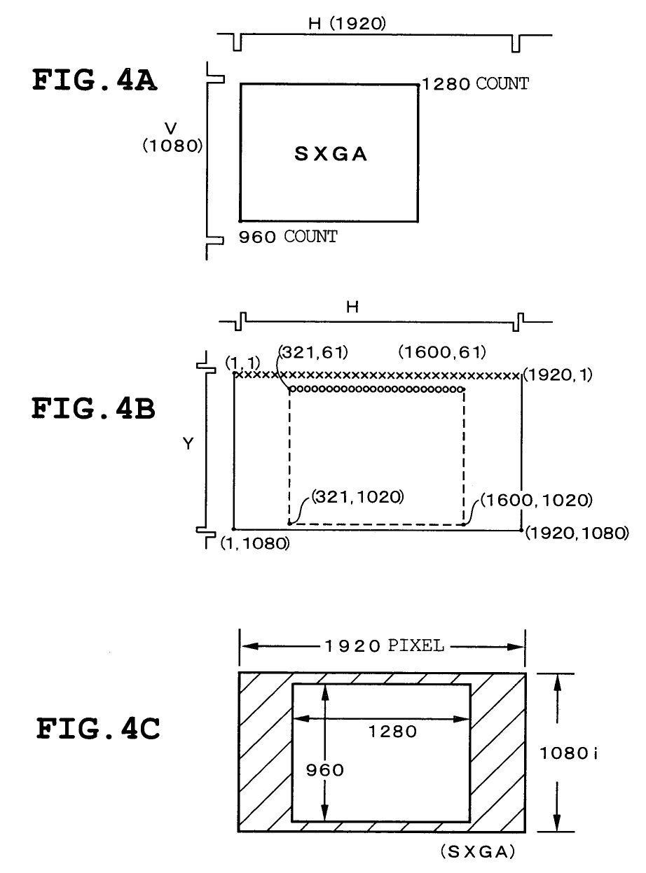

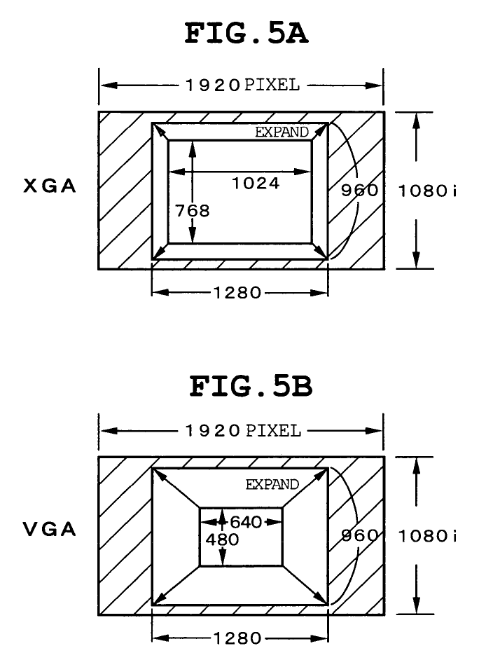

The first embodiment is configured as described above, and the operation is described below by referring to FIGS. 4 and 5. First, in the electronic endoscope apparatus, the CCD 11 in FIG. 3 captures the inside of an observation object, and the capture signal is sampled by the duplex correlation sampling circuit 12 and converted to a digital signal by the A/D converter 17, and then supplied to the selector 18. The selector 18 selects by of the first DSP 19 and the second DSP 20 depending on the type of the connected electronic endoscope 10. For example, the microcomputer 24 reads the information in the memory 13 by the communications between the electronic endoscope 10 and the processor device 16, and selects the first DSP 19 (in the case of inter-line scanning) or the second DSP 20 (in the case of progressive scanning) depending on the number of pixels (or the CCD transfer system corresponding to the number of pixels) of the CCD 11.

In the first DSP 19 or the second DSP 20 and the third DSP 21, various types of image processing are performed, and the output of the third DSP 21 is supplied to the fourth DSP 27 and the analog signal processor 33. The fourth DSP 27 generates a video signal for digital output, and the video signal is output to an external unit through the signal conversion circuit 29, the USB output unit 30, and the network output unit 31, and can be output to a personal computer monitor, etc. through the DVI circuit 28. The analog signal processor 33 generates a video signal for analog output, outputs a Y signal and a C signal through the Y/C signal output unit 34, and output the R, G, and B signals through the RGB output unit 35.

When the output of the DVI circuit 28 is supplied to the high vision system converter 37, the high vision system converter 37 generates a high vision television signal. That is, the signal processing unit 39 of the DVI circuit 28 shown in FIG. 1 generates a video signal in accordance with the display standard corresponding to the number of pixels for CCD 11 such as 640×480 (VGA), 1024×768 (XGA), 1280×960, 1280×1024 (SXGA), etc. The parallel signals which are output from this signal processing unit 39 such as B (blue), G (green), R (red), H (horizontal synchronous signal), V (vertical synchronous signal), C₀, C₁, C₂, C₃ (control signal), etc. are converted to a serial signal by the transmission units 40A, 40B, and 40C, and output to the high vision system converter 37 through the serial transmission cable 41. As shown in FIG. 1, the B signal transmitted from the transmission unit 40A and the signals of H, V, etc. are received by the reception unit 42A, the G signal and other signals transmitted from the transmission unit 40B are received by the reception unit 42B, and the R signal and other signals transmitted from the transmission unit 40C are received by the reception unit 42C. These reception units 42A, 42B, and 42C convert a serial signal to an original parallel signal, and the signal is supplied to the HDTV signal conversion unit (FPGA) 44 through the ICA circuit 43.

In the HDTV signal conversion unit 44, the frame memory 46 stores the input video signal through the memory controller 44c shown in FIG. 2, and the pixel number detection circuit 44a detects the number of pixels of the input video signal according to, for example, the horizontal synchronous signal and the vertical synchronous signal. That is, as shown in FIG. 4A, the horizontal synchronous signal (H) in the high vision system corresponds the length of 1920 pixels, and the vertical synchronous signal (V) corresponds to the length of 1080 pixels. For example, when 1280 horizontal pixels are detected (counted) by the horizontal synchronous signal of the video signal input to the high vision system converter 37, or when 960 vertical pixels are detected by the vertical synchronous signal, it is determined to be an image of 1280×960. Similarly, when 1024 horizontal pixels or 768 vertical pixels are detected, a 1024×768 image of the XGA standard is determined; when 640 horizontal pixels or 480 vertical pixels are detected, a 640×480 image of the VGA standard is determined; and when 1280 horizontal pixels or 1024 vertical pixels are detected, a 1280×1024 image of the SXGA standard is determined. The display pixel number adjustment circuit 47 converts an image of different number of pixels to a predetermined 1280×960 number of pixels. However, when the same number of pixels is used (FIG. 4A), the number of display pixels is not adjusted.

When the detection result of the number of pixels is supplied to the synchronous signal generation circuit 44b and the memory controller 44c, the memory controller 44c controls the read of a video signal from the frame memory 46 depending on the number of pixels. In the case of the above-mentioned image of 1280×960 pixels (SXGA), as shown in FIG. 4B, black color is assigned to all horizontal pixels from 1 to 60 the vertical direction, and the video signals of the above-mentioned 1280×960 pixels are assigned to the 321 to 1600 in the horizontal direction, thereby reading the video signals (RGB signals) in the range encompassed by the pixels (321, 61), (1600, 61), (321, 1020), and (1600, 1020). Black color is assigned to the other pixels. In the signal converter 44d, an RGB signal is converted to Y, Pr, and Pb signals, and the synchronous signal of the Y, Pr, and Pb signals and the synchronous signal are output to the HDTV monitor and the HETV recorder. Thus, as shown in FIG. 4C, the HDTV monitor displays a high vision image with the image of an observation object of 1280×960 pixels arranged in the center area, that is, an image (format D₄) of 1920×1080i (interlace) pixels.

FIG. 5A shows a high vision image obtained when the image of 1024×768 pixels in accordance with the XGA standard is detected. In this case, the display pixel number adjustment circuit 47 enlarges the image of 1024×768 pixels to the size of 1280×960 pixels of an SXGA standard. The expanding process is performed in the pixel data interpolating process, etc. in the horizontal and vertical directions as in the case of the electronic expanding process circuit used in the conventional electronic endoscope apparatus, and the enlarged image is sequentially written to the frame memory 46. Then, by the reading operation as in the case shown in FIG. 4B, the HDTV monitor displays a high vision image with the image of an observation object of 1280×960 pixels arranged in the center area.

FIG. 5B shows a high vision image obtained when an image of 640×480 pixels in accordance with the VGA standard is detected. In this case, the display pixel number adjustment circuit 47 enlarges an image of 640×480 pixels to an image of 1280×960 pixels. As a result, an HDTV monitor displays a high vision image with an image of an observation object of 1280×960 pixels arranged in the center area. In the embodiment, an image of an observation object of any number of pixels can be displayed on a high vision monitor with the number of pixels in accordance with a predetermined SXGA standard.

### Second Embodiment

The second embodiment is a display pixel number adjustment circuit 50 for performing an electronic scaling process in the processor device 16 as shown in FIG. 3. The display pixel number adjustment circuit 50 has, for example, image memory, and connected to the third DSP 21. That is, in the display pixel number adjustment circuit 50, the video signal generated by the third DSP 21 is temporarily stored in the image memory, and the video signal read from the image memory is expanded to a predetermined number of pixels, that is, the number of pixels according to, for example, the SXGA in the electronic scaling process, and is output to the fourth DSP 27.

As in the first embodiment, the image of 1280×960 pixels is not electronically expanded, but an image in accordance with the XGA standard is expanded from 1024×768 pixels to 1280×960 pixels as shown in FIG. 5A, and an image in accordance with the VGA standard is expanded from 640×480 pixels to 1280×960 pixels as shown in FIG. 5B. Thus, the video signal having the unified number of display pixels is supplied to the high vision system converter 37 through the fourth DSP 27 and the DVI circuit 28, and is converted to a high vision television signal as shown in FIG. 4B. As a result, an image of an observation object shot by the CCD 11 having different number of pixels can be displayed by the same number of pixels (screen area) on the high vision monitor, and can be observed.

In the first and second embodiments, an image can be converted to that of the number of pixels of another standard such as an XGA, etc. to be unified, or the size by a unified number of pixels can be set to an image of a smaller number of pixels than the number of pixels of the CCD by performing a pixel reducing process based on the thinning of pixel data by the display pixel number adjustment circuits 47 and 50.

1. An electronic endoscope apparatus, comprising:
various electronic endoscopes for capturing an image of an observation object using solid-state image pickup elements having different numbers of pixels;
a processor device configured to be able to connect these various electronic endoscope, for generating an analog video signal and a digital video signal from a signal obtained by the solid-state image pickup element;
a differential signal output unit which is arranged in the processor device, corresponds to the number of pixels of the solid-state image pickup element and generates a digital video signal in accordance with an external computer display standard, parallel-serial converts the digital video signal, and outputs a differential signal;
a high vision system converter having a pixel number detection circuit which is connected to the differential signal output unit and can be arbitrarily removed from the differential signal output unit, and detects the number of pixels of a digital video signal according to a differential signal input from the differential signal output unit, converting a video signal to a high vision television signal, and outputting a resultant signal; and
a display pixel number adjustment circuit, arranged in the high vision system converter, for matching the number of pixels of a video signal with the predetermined number of display pixels by an electronic scaling based on output of the pixel number detection circuit.

2. The electronic endoscope apparatus according to claim 1, wherein
the high vision system converter converts video signals of different number of pixels to video signals equal to or substantially equal to 1280 pixels in a horizontal direction and 960 pixel in a vertical direction, and displays the image in a center of a high vision screen equal to or substantially equal to 1920 pixels in a horizontal direction and 1080 pixels in a vertical direction.

3. An electronic endoscope apparatus, comprising:
various electronic endoscopes for capturing an image of an observation object using solid-state image pickup elements having different numbers of pixels;
a processor device configured to be able to connect these various electronic endoscope, for generating an analog video signal and a digital video signal from a signal obtained by the solid-state image pickup element;
a display pixel number adjustment circuit, provided in a processor device, for matching the number of pixels of a video signal with the predetermined number of display pixels by electronic scaling;
a differential signal output unit, provided in the processor device, for generating a digital video signal in accordance with an external computer display standard, parallel-serial converting the digital video signal, and outputting the resultant signal as a differential signal; and
a high vision system converter, connected to and arbitrarily removed from the differential signal output unit, for converting the video signal having the predetermined number of display pixels to a high vision television signal, and outputting the resultant signal.

4. The electronic endoscope apparatus according to claim 3, wherein
the high vision system converter converts video signals of different number of pixels to video signals equal to or substantially equal to 1280 pixels in a horizontal direction and 960 pixel in a vertical direction, and displays the image in a center of a high vision screen equal to or substantially equal to 1920 pixels in a horizontal direction and 1080 pixels in a vertical direction.
